(19) United States
(12) Patent Application Publication
(10) Pub. No.: US 2019/0129683 A1
(43) Pub. Date: May 2, 2019

(54) AUDIO APP USER INTERFACE FOR PLAYING AN AUDIO FILE OF A BOOK THAT HAS ASSOCIATED IMAGES CAPABLE OF RENDERING AT APPROPRIATE TIMINGS IN THE AUDIO FILE

(71) Applicant: Sanjeev Kumar Singh, Alpharetta, GA (US)

(72) Inventor: Sanjeev Kumar Singh, Alpharetta, GA (US)

(21) Appl. No.: 15/801,565

(22) Filed: Nov. 2, 2017

Related U.S. Application Data
(60) Provisional application No. 62/578,431, filed on Oct. 28, 2017.
(60) Provisional application No. 62/578,632, filed on Oct. 30, 2017.

(51) Int. Cl. G06F 3/16; G06F 3/0482; G06F 3/0484

(52) U.S. Cl. CPC G06F 3/165; G06F 3/04847; G06F 3/0482

(57) ABSTRACT

A system comprises a data store that stores an audio base content of text present in a hard copy book or an eBook having a plurality of pages with one or more actual book images and a book images base content present in the one or more actual book images of the plurality of pages of the hard copy book or the eBook. The book images base content has content synchronization information that correlates positions of the one or more actual book images within the audio base content with a physical location of appearance of each actual book image of the one or more actual book images on a particular page of the hard copy book or the eBook. The system further comprises a computing device configured to at least: receive a request for playback of the audio base content stored in the data store and in response to the request for playback of the audio base content, retrieve or stream from the data store in a sequence the one or more actual book images within a user interface of an audio application (APP) so that each actual book image appears in the user interface at a designated time in an audio stream of the hard copy book or the eBook. The designated time is based on the content synchronization information.

### CROSS REFERENCE TO RELATED APPLICATIONS

This application claims the priority benefit of the co-pending U.S. Provisional Application Ser. No. 62/578,431 entitled “DISPLAYING IMAGES INCLUDED IN A BOOK AT A TIME OF THEIR APPEARANCE IN A USER INTERFACE PLAYING AN AUDIO FILE OF THE BOOK,” filed on Oct. 29, 2017 and U.S. Provisional Application Ser. No. 62/578,632 entitled “AUDIO APP USER INTERFACE FOR PLAYING AN AUDIO BOOK WITH ASSOCIATED PICTURES,” filed on Oct. 30, 2017, the contents of both are hereby incorporated by reference herein in their entirety.

### BACKGROUND

### 1. Field

Aspects of the present invention relates to an audio application (APP) user interface that is configured to display images included in a book while playing an audio file of the book, and more particularly relate to rendering electronic images such as drawings or figures of graphs appearing a paper or hard copy book in a user interface display along with an audio recitation of the book from the audio file of the narrated book.

### 2. Description of the Related Art

Publishers and/or authors frequently offer audio versions of their books or other written works to consumers. Audio books and other narration audio recordings are often sold on a recorded medium, such as a compact disc or cassette tape. Audio recordings, such as audio books, are often offered in formats and/or packaging.

Publishers and/or authors frequently offer audio versions of their books or other written works to consumers. A user will often listen to an audio book or other narration audio (such as spoken word recordings of magazine or newspaper articles, podcasts, text-to-speech audio content, etc.) using a device that includes both the capability to play audio content and the capability to display visual content. For example, a portable computing device, mobile phone, tablet computer, or electronic book reader (“e-book reader”) capable of playing audio content may also include a display device, such as a touch screen display. Although many such computing devices are frequently utilized by users to listen to digital audio books and other narrated audio recordings, the associated display capabilities of the devices are often underutilized during playback of the audio content. For example, a user may simply be presented with basic audio controls (such as play and pause options) on the display device during playback of the audio content.

Therefore, more complete means for showing actual images such as figures, drawings, graphs of a hard copy book or eBook at the time of audio playback of an audio file of an audio book are needed.

### SUMMARY

Briefly described, aspects of the present invention relate to an audio file of an audio book of a hard copy book or eBook that shows actual images such as figures, drawings, graphs of a hard copy book or eBook at the time of audio playback in a synchronized manner so all available or assorted visual information present in a book is offered for viewing in a user interface of a user device.

In accordance with one illustrative embodiment of the present invention, a system comprises a data store that stores an audio base content of text present in a hard copy book or an eBook having a plurality of pages with one or more actual book images and a book images base content present in the one or more actual book images of the plurality of pages of the hard copy book or the eBook. The book images base content has content synchronization information that correlates positions of the one or more actual book images within the audio base content with a physical location of appearance of each actual book image of the one or more actual book images on a particular page of the hard copy book or the eBook. The system further comprises a computing device, comprising one or more processors, in communication with the data store and that is configured to at least: receive a request for playback of the audio base content stored in the data store and in response to the request for playback of the audio base content, retrieve or stream from the data store in a sequence the one or more actual book images within a user interface of an audio application (APP) so that each actual book image appears in the user interface at a designated time in an audio stream of the hard copy book or the eBook. The designated time is based on the content synchronization information. Consistent with another embodiment, a computer-implemented method for facilitating presentation of a plurality of actual book images is provided. The computer-implemented method comprises under control of one or more computing devices configured with specific computer executable instructions, receiving for storage in a data store an audio base content of text present in a hard copy book or an eBook having a plurality of pages with one or more actual book images, receiving for storage in the data store a book images base content present in the one or more actual book images of the plurality of pages of the hard copy book or the eBook, the book images base content having content synchronization information that correlates positions of the one or more actual book images within the audio base content with a physical location of appearance of each actual book image of the one or more actual book images on a particular page of the hard copy book or the eBook, receiving a request for playback of the audio base content stored in the data store, and in response to the request for playback of the audio base content retrieving or streaming from the data store in a sequence the one or more actual book images within a user interface of an audio application (APP) so that each actual book image appears in the user interface at a designated time in an audio stream of the hard copy book or the eBook, wherein the designated time is based on the content synchronization information.

Consistent with yet another embodiment, a system comprises a data store that stores: an audio base content of a hard copy book or an eBook having a plurality of pages with one or more actual book images in an audio file, a book images base content present in the one or more actual book images of the plurality of pages of the hard copy book or the eBook in a video file associated with the audio file, information regarding the one or more actual book images, wherein each actual book image of the one or more actual book images comprises a video content associated with at least one subject referenced by the audio base content and providing additional information not included within the audio base content regarding the at least one subject, content synchronization information that correlates positions within the audio base content of the audio file with the one or more actual book images of the video file. The system further comprises a computing device, comprising one or more processors, in communication with the data store and that is configured to at least: receive a request for playback of the audio file stored in the data store, in response to the request for playback of the audio file: retrieve, from the data store, the one or more actual book images associated with the audio base content, the one or more actual book images including visual images representing figures, drawings or graphs, receive, from the data store, a first actual book image associated with a first audio content portion and a second actual book image associated with a second audio content portion, wherein the first actual book image is different than the second actual book image, and automatically present for display at least the first actual book image and the second actual book image at different times during playback of corresponding portions of the audio base content, such that (a) the first actual book image is presented for display during playback of the first audio content portion corresponding to a first page of the hard copy book or the eBook and (b) the second actual book image is presented for display during playback of the second audio content portion corresponding to a second page of the hard copy book or the eBook.

### BRIEF DESCRIPTION OF THE DRAWINGS

FIG. 1 illustrates a block diagram depicting an illustrative operating environment in which visual book content related to audio base content may be determined and then presented by a computing device in accordance with an exemplary embodiment of the present invention.

FIG. 2 illustrates a flow chart of a method of making an audio-visual book in accordance with an exemplary embodiment of the present invention.

FIG. 3 illustrates a flow chart of a method of displaying the audio-visual book of FIG. 2 in a user interface in accordance with an exemplary embodiment of the present invention.

FIG. 4 depicts a general architecture of a computing device for presenting two types of base content during playback of an audio content.

FIG. 5 depicts a user interface of a user device to playback the audio-visual book of FIG. 2 in accordance with an exemplary embodiment of the present invention.

FIG. 6 depicts a user interface window of an audio application (APP) configured to playback the audio-visual book of FIG. 2 in a time aligned manner in accordance with an exemplary embodiment of the present invention.

FIG. 7 includes illustrative user interfaces generated for display by a computing device during playback of audio book content, where the user interfaces include visual image book content determined to be related to the audio book content.

FIG. 8 illustrates a flow chart of a method of facilitating presentation of a plurality of actual book images of the audio-visual book in accordance with an exemplary embodiment of the present invention.

### DETAILED DESCRIPTION

To facilitate an understanding of embodiments, principles, and features of the present invention, they are explained hereinafter with reference to implementation in illustrative embodiments. In particular, they are described in the context of an audio application (APP) user interface that is configured to display images included in a book while playing an audio file of the book, and more particularly relate to rendering electronic images such as drawings or figures of graphs appearing a paper or hard copy book in a user interface display along with an audio recitation of the book from the audio file of the narrated book. Embodiments of the present invention, however, are not limited to use in the described devices or methods.

The components and materials described hereinafter as making up the various embodiments are intended to be illustrative and not restrictive. Many suitable components and materials that would perform the same or a similar function as the materials described herein are intended to be embraced within the scope of embodiments of the present invention.

Although some embodiments of this invention may be described and illustrated herein in terms of still book images, it should be understood that embodiments of this invention are not so limited, but are generally applicable to videos of eBooks such URL links embedded in the eBook. Further, although some embodiments of this invention may be described and illustrated herein in the context of separate audio file and video file, it should be understood that embodiments of this invention are not so limited, but are generally applicable to any type of audio/video media formats and combinations.

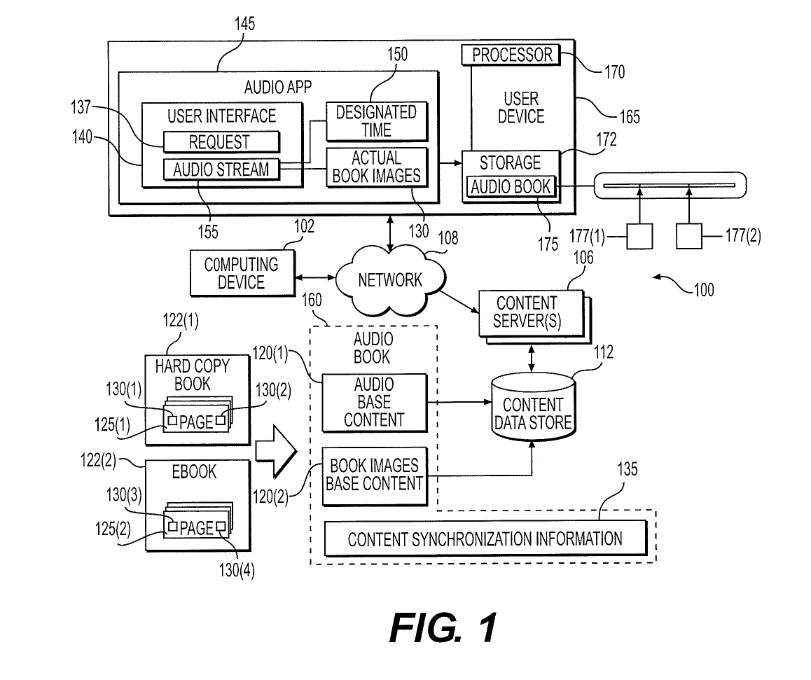

FIG. 1 illustrates a block diagram depicting an illustrative system 100 in which visual book content related to audio base content may be determined and then presented by a computing device 102 in accordance with an exemplary embodiment of the present invention. FIG. 1 depicts the illustrative system 100 in which the computing device 102 and/or one or more content servers 106 may determine visual book content related to primary audio base content, and in which the determined content may then be presented by the computing device 102.

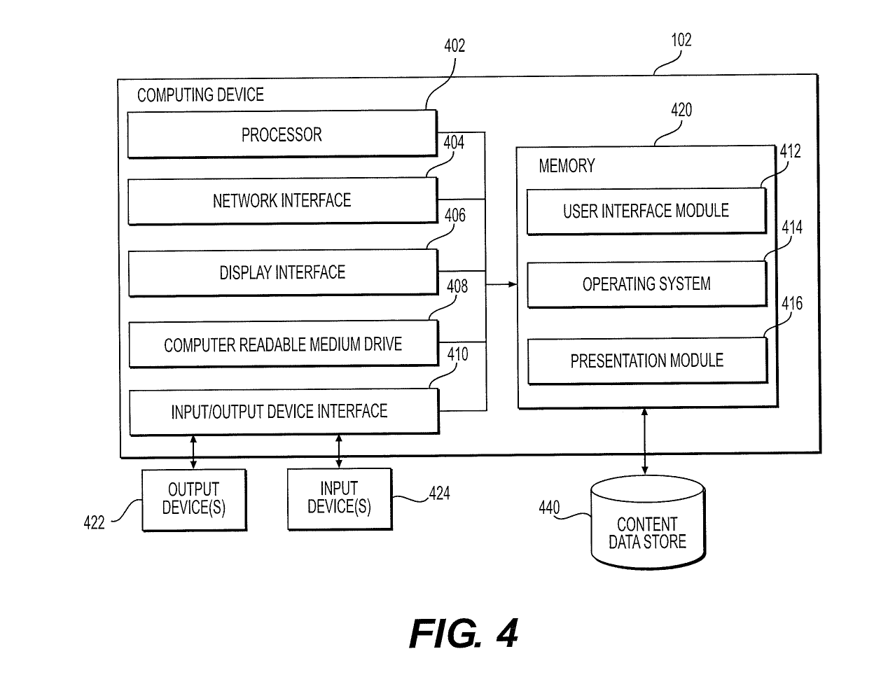

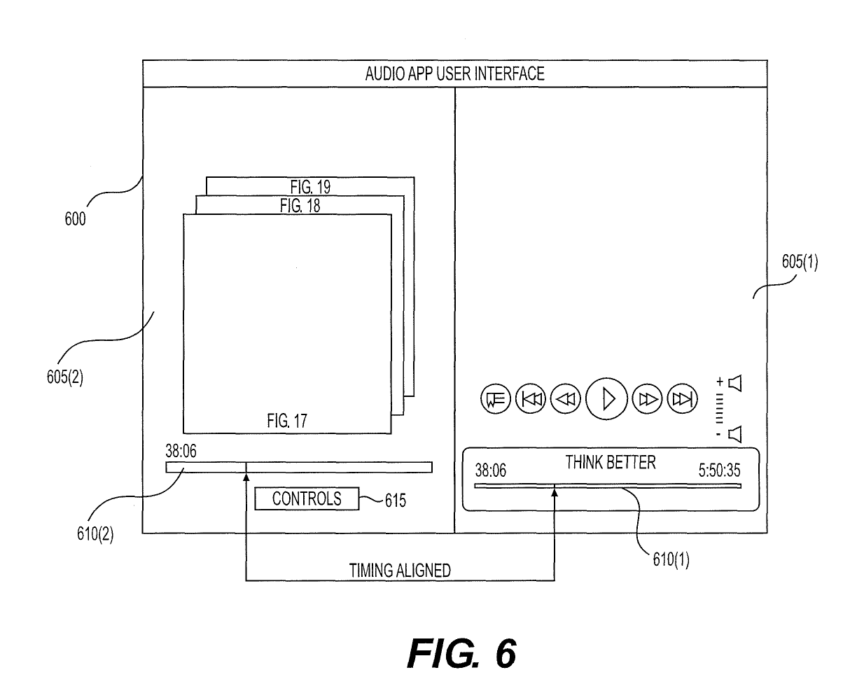

The depicted system 100 includes the computing device 102, and the one or more content servers 106 communicatively connected by a network 108, such as the Internet. Those skilled in the art will recognize that the computing device 102 may collectively be any of a number of computing devices that are capable of communicating over a network including, but not limited to, a laptop, personal computer, tablet computer, electronic book reader, personal digital assistant (PDA), hybrid PDA/mobile phone, mobile phone, smart phone, digital music player, and the like. In the illustrated embodiment, the computing device 102 may output audio content, such as the content of an audio book, to a user while presenting for display visual content associated with the audio content, such as the user interfaces discussed below with reference to FIG. 6. The computing device 102 is discussed in more detail below in reference to FIG. 4.

In the illustrated embodiment, the one or more content servers 106 may determine content associated with primary audio content, such as by accessing information associated with image, audio and/or video content stored in one or more content servers 106. For example, the one or more content servers 106 may determine one or more images associated with the subject matter discussed in a given portion of narration audio content, and may send the image data to computing device 102 for display during playback of the relevant audio content on the computing device 102, as will be further discussed below. In other embodiments, the computing device 102 may determine relevant content with which to supplement primary audio content without communicating with one or more content servers 106. In some embodiments, the content server(s) 106 may include computer hardware and software components similar to those described below with respect to the computing device 102.

In the system 100 shown in FIG. 1, the computing device 102 may communicate with the content server 106 via a communication network 108, such as the Internet or other communications link. Communications between the computing device and/or presentation server and the one or more content servers 106 may be secure, such as by encrypting or encoding the data exchanged. For example, the one or more content servers 106 may provide access to various content data stores, such as content data store 112, that include image content, video content, textual content, audio content, and/or other types of content that are available for public use (such as royalty-free content) or for use according to a license.

As illustrated in FIG. 1, the content server 106 includes or communicates with a content data store 112. The content data store 112 may include data regarding stored presentation settings, companion content (such as electronic book content or transcript text), book images, textual content, audio book keyword information, synchronization information associating portions of audio content with portions of companion content, user and demographic data, and/or other information. Those skilled in the art will appreciate that content data store 112 may be local to the content server 106, may be remote to the content server 106, and/or may be a network-based service itself. In other embodiments, content data store 112 may be local to the computing device 102. Those skilled in the art will appreciate that the network 108 may be any wired network, wireless network or combination thereof. In addition, the network 108 may be a personal area network, local area network, wide area network, cable network, satellite network, cellular telephone network, etc., or combination thereof. Protocols and components for communicating via the Internet or any of the other aforementioned types of communication networks are well known to those skilled in the art of computer communications and, thus, need not be described in more detail herein.

The system 100 includes the content data store 112 that stores an audio base content 120(1) of text present in a hard copy book 122(1) or an eBook 122(2) having a plurality of pages 125(1-2) with one or more actual book images 130(1-4). The content data store 112 also stores a book images base content 120(2) present in the one or more actual book images 130(1-4) of the plurality of pages 125(1-2) of the hard copy book 122(1) or the eBook 122(2). The audio base content 120(1) is a form of a first actual base content in a form of text and the book images base content 120(2) is a form of a second actual base content in a form of images. Both being the audio base content 120(1) as a textual original base content and the book images base content 120(2) as a visual original base content combined together define an original base content of the hard copy book 122(1) or the eBook 122(2).

The audio base content 120(1) and the book images base content 120(2) are from a single source, i.e., the hard copy book 122(1) or the eBook 122(2). The book images base content 120(2) is not any supplemental content providing additional information regarding a subject referenced at a position of consumption as it is the original base content disclosed in the hard copy book 122(1) or the eBook 122(2) in the form of the one or more actual book images 130(1-4) present in the plurality of pages 125(1-2) of the hard copy book 122(1) or the eBook 122(2) just like the textual content being narrated as the audio base content 120(1). Neither the book images base content 120(2) is any companion content for a base content as it is the part of the original base content. Neither the book images base content 120(2) is any additional content associated with one or more keywords as it is the part of the original base content. Neither the book images base content 120(2) is any companion content associated with primary audio content as it is part of the actual original base content present in the plurality of pages 125(1-2) of the hard copy book 122(1) or the eBook 122(2). Moreover, the book images base content 120(2) is retrieved from a same or a single data store, i.e., the content data store 112 from where the audio base content 120(1) is retrieved from.

The book images base content 120(2) having content synchronization information 135 that correlates positions of the one or more actual book images 130(1-4) within the audio base content 120(1) with a physical location of appearance of each actual book image of the one or more actual book images 130(1-4) on a particular page 125 of the hard copy book 122(1) or the eBook 122(2).

The computing device 102 may comprise one or more processors and be in communication with the content data store 112. The computing device 102 may be configured to at least: receive a request 137 for playback of the audio base content 120(1) stored in the content data store 112.

The computing device 102 may be configured to in response to the request for playback of the audio base content 120(1) retrieve or stream from the content data store 112 in a sequence the one or more actual book images 130(1-4) within a user interface 140 of an audio application (APP) 145 so that each actual book image appears in the user interface 140 at a designated time 150 in an audio stream 155 of the hard copy book 122(1) or the eBook 122(2), wherein the designated time 150 is based on the content synchronization information 135.

An audio book 160 may comprise the audio base content 120(1), the book images base content 120(2) and the content synchronization information 135. The audio base content 120(1) may be the audio book 160 of either the hard copy book 122(1) or the eBook 122(2). The audio base content 120(1) may comprise narration audio content.

The computing device 102 is further configured to transmit the one or more actual book images 130(1-4) of the book images base content 120(2) to a user device 165 for presentation to a user. The user device 165 may include a processor 170 and a storage 172 storing an audio book copy 175. The user device 165 may be at least one of a tablet, a laptop, a desktop, a mobile phone, a PDA, an eBook reader, a DVR, or a television.

An actual book image 130 of the one or more actual book images 130(1-4) of the book images base content 120(2) comprises at least one of a figure, a drawing, a rendering, or a graph present in the plurality of pages 125(1-2) of at least one of the hard copy book 122(1) or the eBook 122(2).

The computing device 102 is further configured to causing presentation first of a first actual book image 130(1) and then a second actual book image 130(2) of the one or more actual book images 130(1-4) of the book images base content 120(2) during output of corresponding portions of the audio base content 120(1), such that (a) the first actual book image 130(1) is presented during output of a first audio content portion 177(1) corresponding to a first page 125(1) of the hard copy book 122(1) or the eBook 122(2) and (b) the second actual book image 130(2) is presented during output of a second audio content portion 177(2) corresponding to a second page 125(2) f the hard copy book 122(1) or the eBook 122(2). The first actual book image 130(1) is determined to be associated with the first audio content portion 177(1) based at least in part on metadata associated with the first actual book image 130(1).

The computing device 102 is further configured to storing presentation information identifying a plurality of actual book images of the one or more actual book images 130(1-4). The presentation information includes information that associates each actual book image of the plurality of actual book images with at least a portion of the audio base content 120(1). The presentation information includes presentation settings associated with a user.

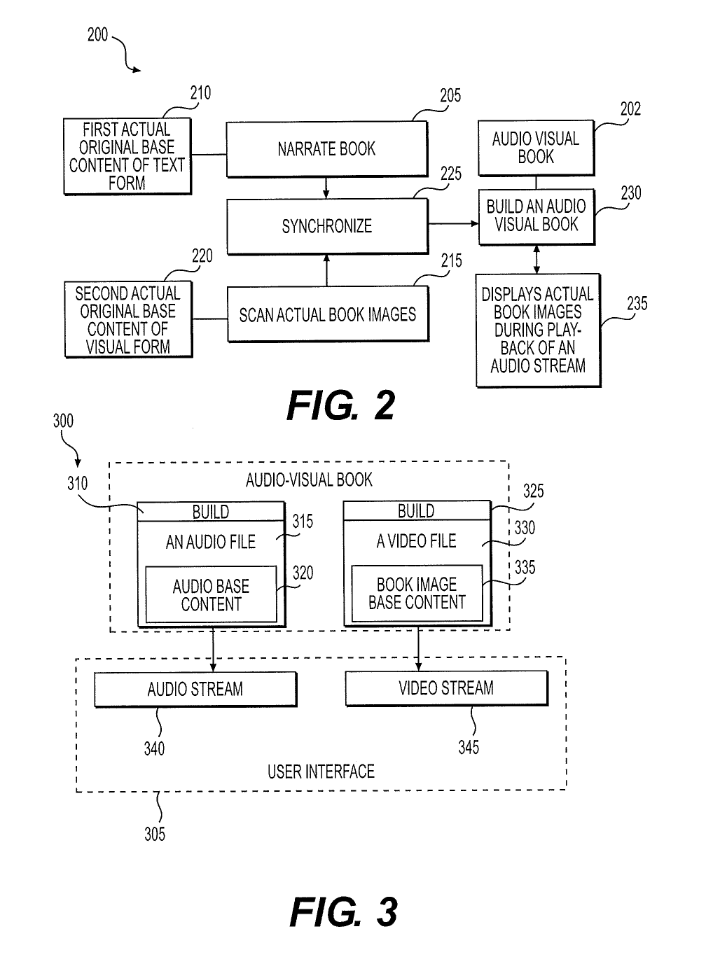

FIG. 2 illustrates a flow chart of a method 200 of making an audio-visual book 202 in accordance with an exemplary embodiment of the present invention. Reference is made to the elements and features described in FIG. 1. It should be appreciated that some steps are not required to be performed in any particular order, and that some steps are optional.

In step 205, the method 200 includes narrating a book. By this narration, a first actual original base content of text form 210 is created. In step 215, the method 200 includes scanning actual book images as a second actual original base content of visual form 220. In step 225, the method 200 includes synchronizing the first actual original base content of text form 210 with the second actual original base content of visual form 220. In this way, in step 230, the audio-visual book 202 may be built. This audio-visual book 202 in step 235 displays actual book images during playback of an audio stream.

FIG. 3 illustrates a flow chart of a method 300 of displaying the audio-visual book of FIG. 2 in a user interface 305 in accordance with an exemplary embodiment of the present invention. Reference is made to the elements and features described in FIG. 1. It should be appreciated that some steps are not required to be performed in any particular order, and that some steps are optional.

In step 310, the method 300 includes building an audio file 315 of an audio base content 320. In step 325, the method 300 includes building a video file 330 of a book images base content 335. In the user interface 305, the audio file 315 may playback in an audio stream 340 and the video file 330 may playback in a video stream 345. Both the audio stream 340 and the video stream 345 may be synchronized in terms of timings of appearance of book images during the audio stream 340. In one embodiment, instead of the video file 330 the book images 130(1-4) may be accessed directly from the content data store 112 by a server and displayed in a display screen of a user device in a sequence.

FIG. 4 depicts a general architecture of the computing device 102 for presenting two types of base content during playback of an audio content. The computing device 102 may have one or more processors 402 in communication with a network interface 404, a display interface 406, a computer readable medium drive 408, and an input/output device interface 410, all of which communicate with one another by way of a communication bus. The network interface 404 may provide connectivity to one or more networks or computing systems. The processor(s) 402 may thus receive information and instructions from other computing systems or services via a network. The processor(s) 402 may also communicate to and from memory 420 and further provide output information or receive input information via the display interface 406 and/or the input/output device interface 410. The input/output device interface 410 may accept input from one or more input devices 424, including, but not limited to, keyboards, mice, trackballs, trackpads, joysticks, input tablets, trackpoints, touch screens, remote controls, game controllers, velocity sensors, voltage or current sensors, motion detectors, or any other input device capable of obtaining a position or magnitude value from a user. The input/output interface 410 may also provide output via one or more output devices 422, including, but not limited to, one or more speakers or any of a variety of digital or analog audio capable output ports, including, but not limited to, headphone jacks, XLR jacks, stereo jacks, Bluetooth links, RCA jacks, optical ports or USB ports, as described above. The display interface 406 may be associated with any number of visual or tactile interfaces incorporating any of a number of active or passive display technologies (e.g., electronic-ink, LCD, LED or OLED, CRT, projection, etc.) or technologies for the display of Braille or other tactile information.

The memory 420 contains computer program instructions that the processor(s) 402 execute in order to implement one or more embodiments of the present disclosure. The memory 420 generally includes RAM, ROM and/or other persistent or non-transitory computer-readable media. The memory 420 may store an operating system 414 that provides computer program instructions for use by the processor(s) 402 in the general administration and operation of the computing device 102. The memory 420 may further include other information for implementing aspects of the present disclosure. For example, in one embodiment, the memory 420 includes a user interface module 412 that facilitates generation of user interfaces (such as by providing instructions therefor) for display. For example, a user interface may be displayed via a navigation interface such as a web browser installed on the computing device. In addition, memory 420 may include or communicate with an auxiliary content data store 440. Data stored in the content data store 440 may include audio content, image content, textual content, and/or other data similar to that discussed above.

In addition to the user interface module 412, the memory 420 may include a presentation module 416 that may be executed by the processor(s) 402. In one embodiment, the presentation module 416 may be used to implement various aspects of the present disclosure, such as determining or requesting content associated with a given portion of primary audio content, presenting visual content for display during playback of audio content, etc.

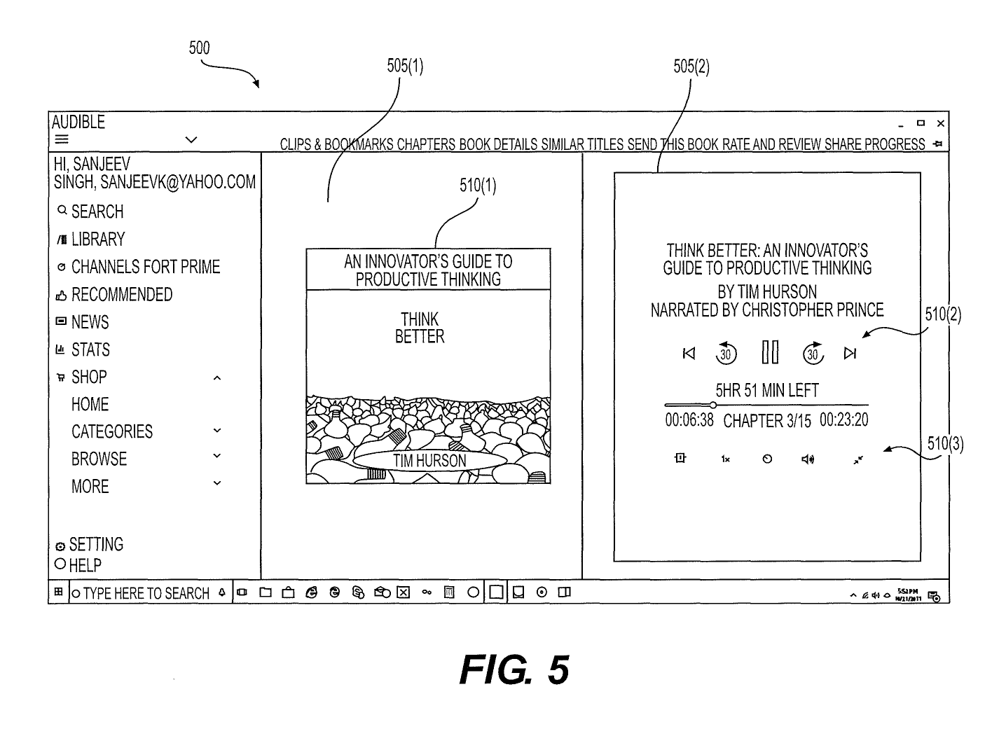

FIG. 5 depicts a user interface 500 of a user device to playback the audio-visual book 202 of FIG. 2 in accordance with an exemplary embodiment of the present invention. The user interface 500 is configured for displaying images included in a book at a time of their appearance in the user interface 500 playing an AUDIO file of the book. For example, in an Audible APP will have figures displayed at the time of their appearance in an AUDIO file of the book.

In a user interface view of the Audible APP open in a display screen may display a diagram or a figure or a graph image as a part of the user interface view. For example, the user interface view has a first area 505(1) with an image 510(1) displayed in it and a second area 505(2) with audio controls 510(2) and audio features 510(3) showing the progress of an audio file of a book being listened to by a user. The Audible APP will use the first area 505(1) where right now a top cover page of the book is constantly displayed throughout the whole length of the audio file. In the first area 505(1), at a co-ordinated time with the audio any FIGURES, DRAWINGS, GRAPHS can be automatically displayed, giving the user a chance to view them as they cannot be converted in audio. In this way, any book regardless of how many drawings, figures, graphs it has such as technical or medical books can be sold as an audio book which is complete and does not leave out and image information while has all the text information included.

FIG. 6 depicts a user interface window 600 of an audio application (APP) configured to playback the audio-visual book 202 of FIG. 2 in a time aligned manner in accordance with an exemplary embodiment of the present invention. The audio APP may be a software APP running on a processor and execution instructions stored in a memory to form the user interface window 600. The processor may be configured to playback an audio file of a book, display audio controls on a first screen area 605(1) and display one or more figures, drawings or graphs in a second screen area 605(2) in a co-ordinated manner such that they appear at their actual physical locations in a physical book during an audio stream 610(1). The audio stream 610(1) is aligned with specific appearances of the figures, drawings or graphs in the second screen area 605(2). For example, in a book titled “Think Better” of length 5:50:35 hours at an audio point 38:06 in the audio stream 610(1) will show a FIG. 17 at a 38:06 location in a video stream 610(2). A user can toggle through other figures such as FIG. 18 and FIG. 19 shown to be lined up in a queue. For example, one or more user controls 615 may be provided which can be similar to an audio controls 620.

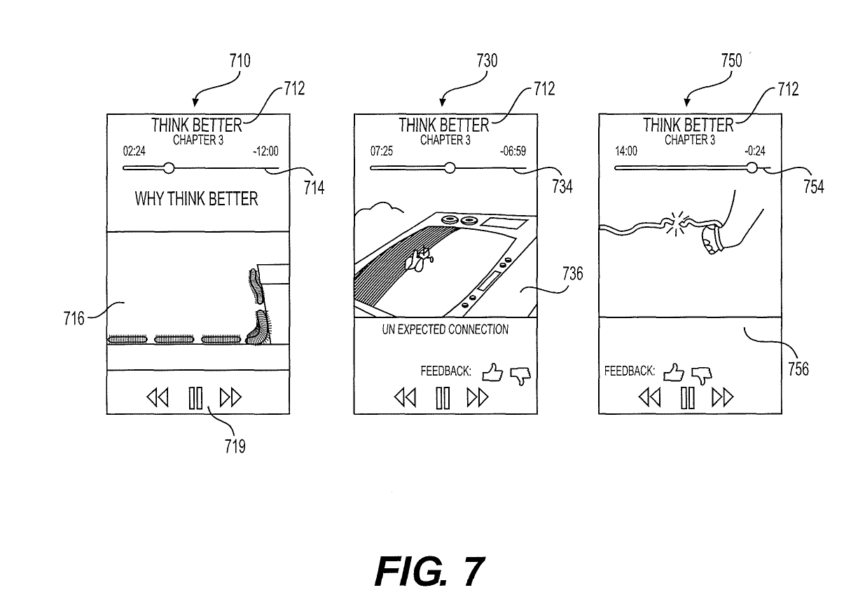

FIG. 7 includes illustrative user interfaces 710, 730 and 750 generated for display by the computing device 102 during playback of an audio book base content. The user interfaces 710, 730 and 750 include visual image book base content determined to be related to the audio book base content.

As illustrated, the user interfaces 710, 730 and 750 include the visual image book base content determined by the computing device 102 and/or the content server(s) 106.

In the illustrated embodiment, the user interface 710 may be presented for display by the computing device 102 while the computing device 102 is playing the audio content of an audio book 712, THINK BETTER. In some embodiments, the computing device 102 may have previously received the audio content for audio book 712, THINK BETTER, from the content sever 106, or another network resource. In other embodiments, the computing device 102 may have received streaming access to the audio content of audio book 712 from one or more network resources. After the computing device 102 received the audio content, or received access to the audio content, the user may have selected to listen to the audio content, such as by the computing device 102 outputting the audio content through speakers, headphones, or other output device associated with computing device 102. As illustrated by audio status bar 714, audio playback of the audio content by the computing device 102 is currently at the 02:24 time mark of Chapter 3 (two minutes and twenty-four seconds into the chapter) of audio book 712, with twelve minutes (indicated by “12:00”) of audio content remaining in the chapter. The user may select audio control options 719 in order to pause playback of the audio, or to skip backwards or forwards within the audio content.

Illustrative user interface 710 includes an image 716 that has been selected by the computing device 102 or the content sever 106 according to aspects of the present disclosure described further below. While user interfaces 710, 730 and 750 will be described below in terms of an embodiment in which the presentation module 416 of computing device 102 determines image content to display, it will be appreciated that the content, in other embodiments, may be determined at least in part by the content sever 106 and sent to the computing device 102 for display. In the illustrated embodiment, image 716 may have been selected by the presentation module 416 for display because the image 716 has been determined to be physically present in the hard copy book 122(1) or the eBook 122(2) next to the subject matter discussed in the narration audio content of audio book 712 (the audio is of the text on a specific page and the image 712 is, e.g., a graph on that page in the actual physical book) at or near the current time mark (02:24) of the audio content.

Systems and methods for creating narration audio that is aligned with a transcript are disclosed in U.S. patent application Ser. No. 12/880,947, filed Sep. 13, 2010, entitled “SYSTEMS AND METHODS FOR CREATING NARRATION AUDIO,” which is hereby incorporated by reference in its entirety. Systems and methods for synchronizing companion content, as well as various formats and types of synchronization content, are disclosed in U.S. patent application Ser. No. 12/273,473, filed Nov. 18, 2008, entitled “SYNCHRONIZATION OF DIGITAL CONTENT,” and U.S. patent application Ser. No. 13/070,313, filed Mar. 23, 2011, entitled “SYNCHRONIZING DIGITAL CONTENT,” each of which is hereby incorporated by reference in its entirety.

Relative to illustrative user interface 710, illustrative user interface 730 may be presented by the computing device 102 to the user during playback of a later portion of the audio content of audio book 712. Specifically, audio status bar 734 of the user interface 730 indicates that the user is currently listening to the audio content at time mark “07:25” (seven minutes and twenty-five seconds) of Chapter 3. The image 736 displayed in the user interface 730 may have been determined by the presentation module 416 to be from a page 50 of the hard copy book 122(1) or the eBook 122(2) and it is being displayed when the subject matter or text of the page 50 is being narrated as a portion of audio content at or near the 07:25 time mark of Chapter 3 of audio book 712. So, there is a direct correlation between the images displayed and audio played as it is based on a relationship of the image and text in the hard copy book 122(1) or the eBook 122(2). This relationship is fixed and locked-in by the synchronization of audio and visual items. The images 736 displayed are not on the fly by some logic or intelligence rather pre-configured.

As indicated by an audio status bar 754 of the user interface 750, the user interface 750 may be presented for display by the computing device 102 while the computing device 102 plays the audio content at time mark “14:00” (fourteen minutes) of Chapter 3's audio content. The image 756 displayed in user interface 750 may have been determined by the presentation module 416 to be present with to the text of the subject matter of the portion of the audio content at or near the 14:00 time mark of Chapter 3 of audio book 712.

As discussed above, the images 716, 736, 756 is the visual base content that may be considered companion to the audio base content of the audio-visual book 202, according to some embodiments. The visual base or primary content is previously synchronized with the narration audio base or primary content, such as a transcript from which a narrator read when recording the narration audio, or an electronic book version of the same underlying work as the narration audio content. As described in more detail in U.S. patent application Ser. No. 13/070,313, entitled “SYNCHRONIZING DIGITAL CONTENT,” which is incorporated by reference above, content synchronization information can include reference points mapping portions of the companion content to corresponding portions of the audio content. In a specific example, content synchronization information can include data that can be used to map a segment of text (such as a word, line, sentence, etc.) of the companion content to a timestamp of a corresponding portion of the audio content.

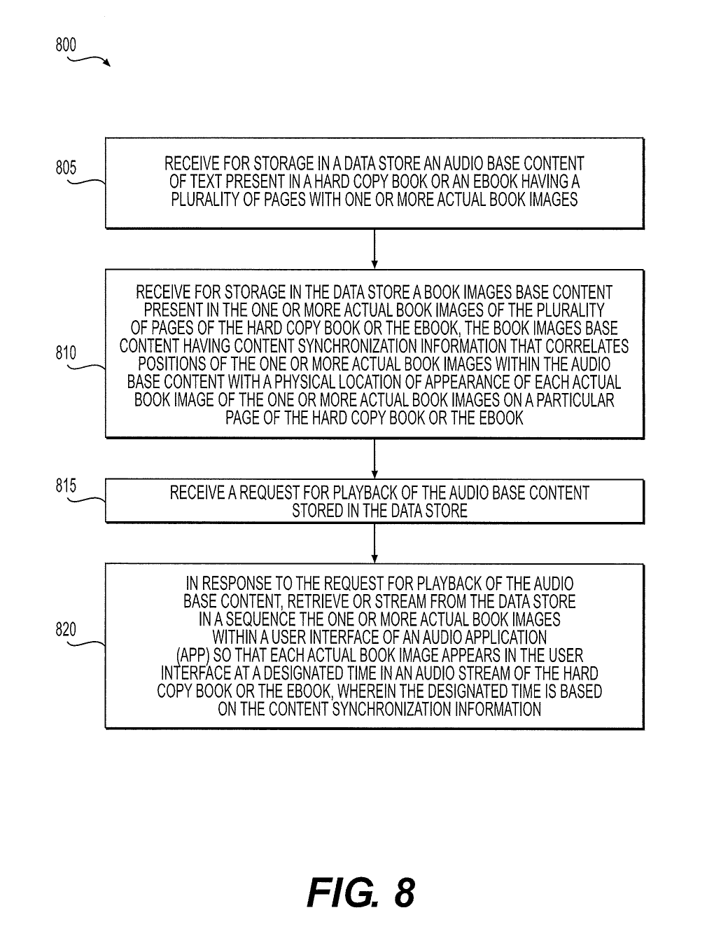

FIG. 8 illustrates a flow chart of a method 800 of facilitating presentation of a plurality of actual book images of the audio-visual book 202 in accordance with an exemplary embodiment of the present invention. Reference is made to the elements and features described in FIG. 1-7. It should be appreciated that some steps are not required to be performed in any particular order, and that some steps are optional.

The method 800 in step 805 includes receiving for storage in a data store an audio base content of text present in a hard copy book or an eBook having a plurality of pages with one or more actual book images. The method 800 in step 810 further includes receiving for storage in the data store a book images base content present in the one or more actual book images of the plurality of pages of the hard copy book or the eBook. The book images base content having content synchronization information that correlates positions of the one or more actual book images within the audio base content with a physical location of appearance of each actual book image of the one or more actual book images on a particular page of the hard copy book or the eBook.

The method 800 in step 815 further includes receiving a request for playback of the audio base content stored in the data store. The method 800 in step 810 further includes, in response to the request for playback of the audio base content, retrieving or streaming from the data store in a sequence the one or more actual book images within a user interface of an audio application (APP) so that each actual book image appears in the user interface at a designated time in an audio stream of the hard copy book or the eBook. The designated time is based on the content synchronization information.

A system comprises a data store that stores: an audio base content of a hard copy book or an eBook having a plurality of pages with one or more actual book images in an audio file and a book images base content present in the one or more actual book images of the plurality of pages of the hard copy book or the eBook in a video file associated with the audio file. The data store further stores information regarding the one or more actual book images, wherein each actual book image of the one or more actual book images comprises a video content associated with at least one subject referenced by the audio base content and providing additional information not included within the audio base content regarding the at least one subject. The data store further stores content synchronization information that correlates positions within the audio base content of the audio file with the one or more actual book images of the video file.

A computing device, comprising one or more processors, in communication with the data store and that is configured to at least: receive a request for playback of the audio file stored in the data store, in response to the request for playback of the audio file: retrieve, from the data store, the one or more actual book images associated with the audio base content, the one or more actual book images including visual images representing figures, drawings or graphs, receive, from the data store, a first actual book image associated with a first audio content portion and a second actual book image associated with a second audio content portion, wherein the first actual book image is different than the second actual book image and automatically present for display at least the first actual book image and the second actual book image at different times during playback of corresponding portions of the audio base content, such that (a) the first actual book image is presented for display during playback of the first audio content portion corresponding to a first page of the hard copy book or the eBook and (b) the second actual book image is presented for display during playback of the second audio content portion corresponding to a second page of the hard copy book or the eBook.

While embodiments of the present invention have been disclosed in exemplary forms, it will be apparent to those skilled in the art that many modifications, additions, and deletions can be made therein without departing from the spirit and scope of the invention and its equivalents, as set forth in the following claims.

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure embodiments in detail. It should be understood, however, that the detailed description and the specific examples, while indicating preferred embodiments, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

In the foregoing specification, the invention has been described with reference to specific embodiments. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Although the steps, operations, or computations may be presented in a specific order, this order may be changed in different embodiments. In some embodiments, to the extent multiple steps are shown as sequential in this specification, some combination of such steps in alternative embodiments may be performed at the same time.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It will also be appreciated that one or more of the elements depicted in the drawings/figures can also be implemented in a more separated or integrated manner, or even removed or rendered as inoperable in certain cases, as is useful in accordance with a particular application.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A system comprising:
a data store that stores:
an audio base content of text present in a hard copy book or an eBook having a plurality of pages with one or more actual book images;
a book images base content present in the one or more actual book images of the plurality of pages of the hard copy book or the eBook, the book images base content having content synchronization information that correlates positions of the one or more actual book images within the audio base content with a physical location of appearance of each actual book image of the one or more actual book images on a particular page of the hard copy book or the eBook; and
a computing device, comprising one or more processors, in communication with the data store and that is configured to at least:
receive a request for playback of the audio base content stored in the data store;
in response to the request for playback of the audio base content:
retrieve or stream from the data store in a sequence the one or more actual book images within a user interface of an audio application (APP) so that each actual book image appears in the user interface at a designated time in an audio stream of the hard copy book or the eBook, wherein the designated time is based on the content synchronization information.

2. The system of claim 1, wherein the computing device is further configured to:
transmit the one or more actual book images of the book images base content to a user device for presentation to a user.

3. The system of claim 2, wherein the user device is at least one of a tablet, a laptop, a desktop, a mobile phone, a PDA, an eBook reader, a DVR, or a television.

4. The system of claim 1, wherein the audio base content is an audio book of at least one of the hard copy book or the eBook.

5. The system of claim 1, wherein an actual book image of the one or more actual book images of the book images base content comprises at least one of a figure, a drawing, a rendering, or a graph present in the plurality of pages of at least one of the hard copy book or the eBook.

6. The system of claim 1, wherein the computing device is further configured to:
causing presentation first of a first actual book image and then a second actual book image of the one or more actual book images of the book images base content during output of corresponding portions of the audio base content, such that (a) the first actual book image is presented during output of a first audio content portion corresponding to a first page of the hard copy book or the eBook and (b) the second actual book image is presented during output of a second audio content portion corresponding to a second page of the hard copy book or the eBook.

7. The system of claim 6, wherein the audio base content comprises narration audio content.

8. The system of claim 6, wherein the first actual book image is determined to be associated with the first audio content portion based at least in part on metadata associated with the first actual book image.

9. The system of claim 1, wherein the computing device is further configured to:
storing presentation information identifying a plurality of actual book images of the one or more actual book images, wherein the presentation information includes information that associates each actual book image of the plurality of actual book images with at least a portion of the audio base content.

10. The system of claim 8, wherein the presentation information includes presentation settings associated with a user.

11. A computer-implemented method for facilitating presentation of a plurality of actual book images, the computer-implemented method comprising: under control of one or more computing devices configured with specific computer executable instructions,
receiving for storage in a data store an audio base content of text present in a hard copy book or an eBook having a plurality of pages with one or more actual book images;
receiving for storage in the data store a book images base content present in the one or more actual book images of the plurality of pages of the hard copy book or the eBook, the book images base content having content synchronization information that correlates positions of the one or more actual book images within the audio base content with a physical location of appearance of each actual book image of the one or more actual book images on a particular page of the hard copy book or the eBook;
receiving a request for playback of the audio base content stored in the data store; and
in response to the request for playback of the audio base content retrieving or streaming from the data store in a sequence the one or more actual book images within a user interface of an audio application (APP) so that each actual book image appears in the user interface at a designated time in an audio stream of the hard copy book or the eBook, wherein the designated time is based on the content synchronization information.

12. The computer-implemented method of claim 11, further comprising:
transmitting the one or more actual book images of the book images base content to a user device for presentation to a user.

13. The computer-implemented method of claim 12, wherein the user device is at least one of a tablet, a laptop, a desktop, a mobile phone, a PDA, an eBook reader, a DVR, or a television.

14. The computer-implemented method of claim 11, wherein the audio base content is an audio book of at least one of the hard copy book or the eBook.

15. The computer-implemented method of claim 11, wherein an actual book image of the one or more actual book images of the book images base content comprises at least one of a figure, a drawing, a rendering, or a graph present in the plurality of pages of at least one of the hard copy book or the eBook.

16. A system comprising:
a data store that stores:
an audio base content of a hard copy book or an eBook having a plurality of pages with one or more actual book images in an audio file,
a book images base content present in the one or more actual book images of the plurality of pages of the hard copy book or the eBook in a video file associated with the audio file,
information regarding the one or more actual book images, wherein each actual book image of the one or more actual book images comprises a video content associated with at least one subject referenced by the audio base content and providing additional information not included within the audio base content regarding the at least one subject,
content synchronization information that correlates positions within the audio base content of the audio file with the one or more actual book images of the video file; and
a computing device, comprising one or more processors, in communication with the data store and that is configured to at least:
receive a request for playback of the audio file stored in the data store;
in response to the request for playback of the audio file: retrieve, from the data store, the one or more actual book images associated with the audio base content, the one or more actual book images including visual images representing figures, drawings or graphs;
receive, from the data store, a first actual book image associated with a first audio content portion and a second actual book image associated with a second audio content portion, wherein the first actual book image is different than the second actual book image; and
automatically present for display at least the first actual book image and the second actual book image at different times during playback of corresponding portions of the audio base content, such that (a) the first actual book image is presented for display during playback of the first audio content portion corresponding to a first page of the hard copy book or the eBook and (b) the second actual book image is presented for display during playback of the second audio content portion corresponding to a second page of the hard copy book or the eBook.

17. The system of claim 16, wherein the computing device is further configured to:
transmit the one or more actual book images of the book images base content to a user device for presentation to a user.

18. The system of claim 17, wherein the user device is at least one of a tablet, a laptop, a desktop, a mobile phone, a PDA, an eBook reader, a DVR, or a television.

19. The system of claim 16, wherein the audio base content is an audio book of at least one of the hard copy book or the eBook.

20. The system of claim 16, wherein an actual book image of the one or more actual book images of the book images base content comprises at least one of a figure, a drawing, a rendering, or a graph present in the plurality of pages of at least one of the hard copy book or the eBook.
